(19) United States
(12) Patent Application Publication
(10) Pub. No.: US 2023/0066314 A1
(43) Pub. Date: Mar. 2, 2023

(54) METHOD AND DEVICE FOR PRESERVING CONTEXT IN CONVERSATIONS

(71) Applicant: KONINKLIJKE PHILIPS N.V., EINDHOVEN (NL)

(72) Inventors: SHREYA ANAND, BANGALORE (IN); RITHESH SREENIVASAN, BANGALURU (IN); SHEIKH SADID AL HASAN, CAMBRIDGE, MA (US); OLADIMEJI FEYISETAN FARRI, CAMBRIDGE, MA (US)

(21) Appl. No.: 17/797,313

(22) PCT Filed: Feb. 5, 2021
(86) PCT No.: PCT/EP2021/052886

§ 371 Date: Aug. 3, 2022

Related U.S. Application Data
(60) Provisional application No. 62/971,392, filed on Feb. 7, 2020.

(51) Int. Cl. G10L 15/183; G10L 15/06

(52) U.S. Cl. CPC G10L 15/183; G10L 15/063; G10L 2015/0631

(57) ABSTRACT

The present disclosure relates to preserving context in a conversation between a user (101) and a digital assistant device (102). During training, the digital assistant device (102) is provided with a plurality of conversations having a plurality of dialogues. Each of the plurality of dialogue is assigned an ID based on a context. Further, two or more test queries having a same context is provided as input and the two are more queries are assigned an ID based on the context. Thereafter, the digital assistant device (102) is configured to retrieve one or more dialogues from the plurality of dialogues where the ID of the one or more dialogues match the ID of the two or more queries. In real-time, one or more queries are received and based on a context of the one or more queries, one or more dialogues are retrieved and are provided to the user.

### FIELD OF THE INVENTION

The present disclosure relates in general to digital assistant devices. More particularly, but not specifically, the present disclosure relates to method for preserving context of dialogues in conversations between users and a digital assistant device.

### BACKGROUND OF THE INVENTION

Digital assistant devices are used in various domains due to their capability of generating conversations naturally. The ability to process and generate natural conversations is important as natural language is easily understood by humans. However, it is a challenge to process and generate natural language.

New technologies like Artificial Intelligence (AI), machine learning, deep learning are used to improve the capabilities of digital assistant devices. Natural Language Processing (NLP) is a domain that deals with speech recognition and speech generation. Techniques like Recurrent Neural Networks (RNN) are used for speech recognition and speech generation. RNN based models like Long Short Term Memory (LSTM), Bi-LSTM, End-to-End Memory Network (memN2N) are used in digital assistant devices.

Question-answer based applications not only need to recognize and generate natural speeches, but also have to preserve the context of dialogues while conversing with a user. Typically, humans understand the context while speaking with other humans, hence, the keywords defining the context may not be repeated in every dialogue. However, the digital voice assistant devices do not accurately preserve the context during a conversation.

Existing techniques use memN2N to train digital assistant devices. MemN2N uses external memory to store training data. A large number of training data is stored in the external memory. As external memory is used, extensive training data can be stored. Also, the memN2N is trained end-to-end and may not need supervision for each layer of the network. Although, the existing techniques use memN2N, as context is not preserved, the output of the digital assistant device is not accurate.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

In an embodiment, the present disclosure discloses a method for preserving context in a conversation. The method is performed by a digital assistant device, and the method comprises receiving one or more queries. Further, a context of each of the one or more queries is determined. Furthermore, in response to the one or more queries, one or more dialogues from a plurality of dialogues stored in an external memory are retrieved, based on the context of each of the one of more queries and an Identity (ID) assigned to each of the plurality of dialogues based on a context of each of the plurality of dialogues. Thereafter, the one or more dialogues are provided in response to the one or more queries. The one or more dialogues provided in response to the one or more queries forms a conversation and the context of the conversation is preserved as the one or more dialogues are provided based on the context of the one or more queries.

In an embodiment, a digital assistant device for preserving context in a conversation is disclosed. The digital assistant device comprises one or more processors and a memory. The one or more processors receive one or more queries. Further, the one or more processors determine a context of the one or more queries. Furthermore, the one or more processors retrieve one or more dialogues from a plurality of dialogues stored in an external memory based on the context of the one or more queries, and an Identity (ID) associated with each of the one or more dialogues, where the plurality of dialogues are provided with the ID based on a context of the one or more dialogues. Further, the one or more dialogues are provided in response to the one or more queries, where the one or more queries and the one or more dialogues provided in response to the queries form a conversation, where the context of the conversation is preserved as the one or more dialogues are provided based on the context of the one or more queries.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 is illustrative of an environment of a conversation between a user and a digital assistant device, in accordance with an embodiment of the present disclosure;

FIG. 2 is illustrative of internal architecture of a digital assistant device for preserving context in a conversation, in accordance with an embodiment of the present disclosure;

FIG. 3 illustrates a flow chart for training a digital assistant device to preserve context in a conversation, in accordance with an embodiment of the present disclosure;

FIG. 4 illustrate an exemplary scenario of a conversation between a user and a domain expert while training a digital assistant device, in accordance with an embodiment of the present disclosure;

FIG. 5 illustrates a flow chart for preserving a context in a conversation by a digital assistant device, in accordance with an embodiment of the present disclosure;

FIG. 6 illustrates an exemplary scenario of a conversation between a user and a digital assistant device, in accordance with an embodiment of the present disclosure; and

FIG. 7 shows a general-purpose computer system for preserving context in a conversation, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to preserving context in a conversation between a user and a digital assistant device. The digital assistant device is trained to provide appropriate dialogues in response to user queries. During training, the digital assistant device is provided with a plurality of conversations between a user and a domain expert. A plurality of dialogues in the plurality of conversations are stored in an external memory and each of the plurality of dialogue is assigned an Identifier (ID) based on a context of each dialogue. Further, two or more test queries having a same context is provided as input and the two or more queries are assigned an ID based on the context. Thereafter, the digital assistant device is configured to retrieve one or more dialogues from the plurality of dialogues where the ID of the one or more dialogues match the ID of the two or more queries. Therefore, although the vocabulary of the test query changes, the context remains the same, and the digital assistant device retrieves the one or more dialogues in the same context based on the training. Further, in real-time, one or more queries are received from a user and a context of the one or more queries are determined. Thereafter, one or more dialogues from the plurality of dialogues are retrieved from the external memory based on the context of the one or more queries and are provided to the user in response to the one or more queries. Thus, the context of the conversation between the user and the digital assistant device is preserved.

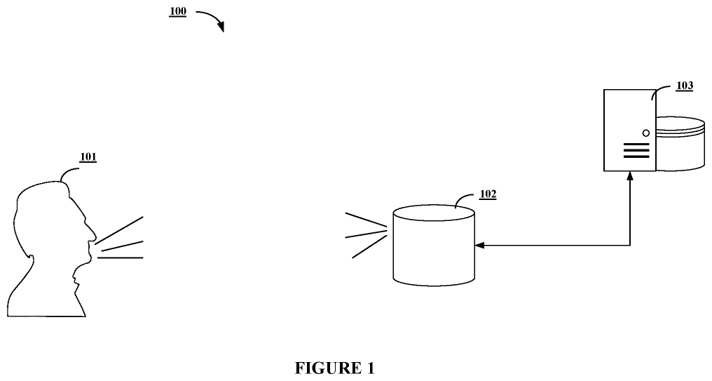

FIG. 1 illustrates an environment (100) of a conversation between a user (101) and a digital assistant device (102). The digital assistant device (102) may be connected to a server (103) hosting a database (also referred as external memory). The external memory may comprise of a plurality of data related to a domain in which the digital assistant device (102) is trained. For example, the digital assistant device (102) may be trained to make conversations related to medical field, business, engineering, specific industries or general conversations. For example, the digital assistant device (102) may be used for making hotel reservations, provide call centre services and the like. The digital assistant device (102) may also be used in medical field for providing paediatrics services. The digital assistant device (102) may be used to provide suggestions and recommendations to users regarding paediatrics. In an embodiment, the digital assistant device (102) may be trained with a plurality of conversations related to paediatrics. In an embodiment, the external memory may comprise a plurality of dialogues related to paediatrics. Every conversation made in real-time may be stored in the external memory for subsequent use. The digital assistant device (102) may receive one or more queries from the user (101) and provide one or more dialogues in response to the one or more queries. The interaction between the user (101) and the digital assistant device (102) may be a natural conversation, where the context may not change although, each of the one or more queries and the one or more dialogues may not specify the context of the conversation. In an embodiment, the digital assistant device (102) may be implemented in an electronic device such as, but not limited to a smartphone, a laptop, a Personal Digital Assistant (PDA), a smart watch, a tablet, a computer, and the like. In an embodiment, the digital assistant device (102) may host an application in the electronic device to implement the features of the digital assistant device (102). In an embodiment, the digital assistant device (102) may be a standalone device (for example Google® Home® or Amazon® Echo®). In an embodiment, the user (101) may not be limited to one user and may indicate one or more users. The digital assistant device (102) may be capable of recognizing speech from a plurality of users and distinguish the voices of the plurality of users. For example, when two users are conversing, the digital assistant device (102) may be capable of recognizing dialogues of both the users and may be used during training. Also, in another example, when a first user asks a question on a topic and a second user asks a subsequent question on the topic, the digital assistant device (102) may be capable of answering both the users related to the topic and may not deviate from the topic because of query asked by a different user.

In an embodiment, the digital assistant device (102) may communicate with the server (103) through a communication network (not shown). The digital assistant device (102) may be disposed in communication with the communication network via a network interface (not shown). The network interface may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, wired connection, e-commerce network, a peer to peer (P2P) network, Local Area Network (LAN), Wide Area Network (WAN), wireless network (e.g., using Wireless Application Protocol (WAP)), the Internet, Wireless Fidelity (Wi-Fi), etc.

In an embodiment, the digital assistant device (102) may include one or more sensors, a display module and one or more speakers (not shown). The one or more sensors may be used to, but not limited to, recognize voices, and determine users in the proximity. In an embodiment, the digital assistant device (102) may perform one or more actions based on inputs from one or more smart devices. For example, the digital assistant device (102) may alert the user when an email is received, schedule a cab based on calendar events of the user and the like.

In an embodiment, the digital assistant device (102) may also be used to control the one or more smart devices such as (smart television, smart speakers, smart lights and the like). In an embodiment, the digital assistant device (102) may be connected to Internet via a local access point. Alternatively, the digital assistant device (102) may be connected to the Internet via Local Area Network (LAN) connection.

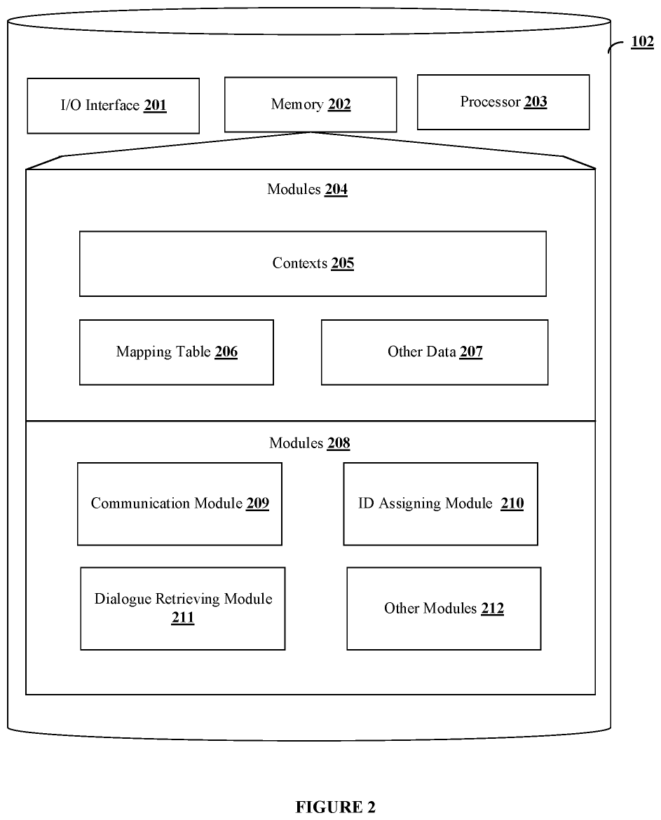

FIG. 2 is an exemplary illustration of internal structure of the digital assistant device (102) configured to preserve context in a conversation, in accordance with some embodiments of the present disclosure. The digital assistant device (102) may include at least one Central Processing Unit (“CPU” or “processor”) (203) and a memory (202) storing instructions executable by the at least one processor (203). The processor (203) may comprise at least one data processor for executing program components for executing user or system-generated requests. The memory (202) is communicatively coupled to the processor (203). The image processing apparatus (101) further comprises an Input/Output (I/O) interface (201). The I/O interface (201) is coupled with the processor (203) through which an input signal or/and an output signal is communicated.

In an embodiment, data (204) may be stored within the memory (202). The data (204) may include, for example, context (205), a mapping table (206) and other data (207).

In an embodiment, the context data (205) may include patterns of characters of the one or more queries, a plurality of vectors indicating at least one of meaning of the one or more queries, the meaning of the one or more dialogues and a relationship between the plurality of vectors. In an embodiment, the relationship between the plurality of vectors may be determined using a cosine similarity between the plurality of vectors. In an embodiment, the context data (205) may also include synonyms and antonyms of phrases to determine the meaning of the one or more queries and the one or more dialogues.

In an embodiment, the mapping table (206) may map each of the one or more queries and each of the one or more dialogues with respective contexts. Further, each context may be associated with an Identifier (ID). As a result of the mapping and the ID associated with each context, an ID is assigned for each of the one or more queries and the one or more dialogues based on the context.

In an embodiment, the other data (207) may include, but not limited to, training data, bias parameters, weight parameters. The training data may include a plurality of queries and a plurality of dialogues of a conversation during a training stage. For example, several conversations between a user and a domain expert such as a paediatrician may be provided as training data to the digital assistant device (102). The bias parameters may be used to match the one or more queries with the plurality of queries provided in the training data. The weight parameters are used to reduce errors in the digital assistant device (102). The bias parameters and the weight parameters are used to implement an End-to-End Memory Network Model (memN2N) in the digital assistant device (102).

In an embodiment, the data (204) in the memory (202) is processed by modules (208) of the digital assistant device (102). As used herein, the term module refers to an Application Specific Integrated Circuit (ASIC), an electronic circuit, a Field-Programmable Gate arrays (FPGA), Programmable System-on-Chip (PSoC), a combinational logic circuit, and/or other suitable components that provide the described functionality. The modules (208) when configured with the functionality defined in the present disclosure will result in a novel hardware.

In one implementation, the modules (208) may include, for example, a communication module (209), an ID assigning module (210), a dialogue retrieving module (211), and other modules (212). It will be appreciated that such aforementioned modules (209) may be represented as a single module or a combination of different modules.

In an embodiment, the communication module (209) may be configured to communicate with the user (101) and the one or more smart devices. In an embodiment, the communication module (209) may be integrated with one or more hardware components like a microphone, a light module, a display module, a Wireless Fidelity (Wi-Fi) module, a Bluetooth module, a speaker module and the like configured in the digital assistant device (102). For example, the communication module (209) may make use of the display module to display a message. In another example, the communication module (209) may make use of the speaker module to convey a message. In another example, the communication module (209) may make use of the Wi-Fi module to communicate with the one or more smart devices. The communication module (209) may receive the one or more dialogues and the one or more queries (test queries and real-time queries) from the user (101). The communication module (209) may pre-process the one or more queries (where one or more queries are speech signals) such as, but not limited to, reducing noise in the speech signals, converting the speech signals into feature vectors, increasing signal to noise ratio, and the like. The pre-processed signals are provided for further processing by the subsequent modules.

In an embodiment, the ID assigning module (210) may be configured to receive the pre-processed signals from the communication module (209). Further, the ID assigning module (210) may assign an ID to each dialogue from the plurality of dialogues of the plurality of conversations during the training stage. The ID assigning module (210) may be configured to determine a context of each dialogue from the plurality of dialogues before assigning the ID. In an embodiment, the ID assigning module (210) may determine the context using conventional techniques such as natural language processing techniques, for example deep neural Hidden Markov Model (HMM). The feature vectors generated by the communication module (209) may be used to determine the context. A feature vector may be generated for each word and each sentence. Each feature vector may indicate a plurality of parameters such as number of words in a sentence, part of speech of a word, relationship of one word with another word, subject and object in a sentence and the like. Based on the plurality of parameters indicated by the feature vectors, the context of each dialogue is determined. Likewise, the ID is determined for each of the two or more test queries. Further, for each determined context, a unique ID is associated by the ID assigning module (210). Thereafter, for each dialogue from the plurality of dialogues, the ID is assigned based on the determined context. An example of ID and associated context is shown in Table 1:

TABLE 1

| ID | Context |
|---|---|
| Contxt1 | Drinking habits of toddlers |
| Contxt2 | Eating habits of toddlers |
| Contxt3 | Food for babies aged between 2 months - 5 |
| | months |
| Contxt4 | Food habits for babies aged between 1 year - |
| | 3 years |

An example of queries and dialogues associated with each ID is shown in Table 2:

TABLE 2

| ID | Dialogues |
|---|---|
| Contxt1 | How many times should my toddler drink |
| | water in a day? |
| | Toddlers should drink at least half a litre |
| | water in a day |
| | Should toddler drink only warm water? |
| | Toddlers may drink warm or room |
| | temperature water |
| Contxt2 | What food should I give to a toddler? |
| | Best foods for toddlers include fruits, |
| | bread, eggs, beans, yogurt |
| | Can I serve sea food to toddlers? |
| | Yes, you can serve sea food to toddlers |
| Contxt3 | What should I feed a 3 months old baby? |
| | Liquid foods are preferred for 3 months |
| | old babies |
| | Can I give sea food? |
| | Yes, you can serve sea food to toddlers |

In an embodiment, the Table 2 may include dialogues and queries. Further, the one or more dialogues and the one or more queries may be mapped based on supervised or unsupervised learning. For example, during a training stage, a domain expert may provide feedback for every dialogue retrieved for a query. Thus, a map may be developed between the queries and the dialogues. Hence, with help of supervision from the domain expert, the ID assigning module (210) may generate the map. In another embodiment, in real-time, the user (101) may provide a feedback whether the provided dialogue in response to a query is satisfactory or not, or the digital assistant device may determine by a reaction of the user (101) whether the provided dialogue is correct or not. Based on the feedback from the user (101) or the determination made by the digital assistant device (102), the map may be generated. In an embodiment, the one or more queries provided in real-time may not associated with the ID. In an embodiment, the ID assigning module (210) may only determine a context of the one or more queries provide in real-time by the user (101). For example, considering a query “what should my toddler eat?”, the context of the query from Table 1 corresponds to “eating habits of toddlers”. Further, the ID assigning module (210) may be configured to determine if the determined context of the one or more queries is stored in the external memory. The ID assigning module (210) may generate a signal when the determined context is not stored in the external memory. Consequently, a notification may be provided to the user (101) that the digital assistant device (102) may not be able to assist the user (101) for the provided one or more query.

In an embodiment, the dialogue retrieving module (211) may be configured to retrieve one or more dialogues from the external memory based on one of the two or more test queries or one or more queries. In an embodiment, the two or more test queries are the queries provided to the digital assistant device (102) during the training stage and the one or more queries are the real-time queries provided by the user (101) for seeking assistance of the digital assistant device (102). During the training stage, the dialogue retrieving module (211) retrieves the one or more dialogues from the external memory based on the context of the two or more test queries. In an embodiment, the dialogue retrieving module (211) may retrieve the one or more dialogues having an ID same as the ID assigned to the two or more test queries. In an embodiment, the two or more test queries may be provided in a single instance or the two or more queries may be provided at different instances, but may be a part of a conversation where the two or more test queries have a same context. For example, the two or more test queries may be provided at once such as,

User: “Hi, I want to know what food can I feed my 3-months old baby”. “And also tell me how frequently should my baby drink water”.
In this example the two or more queries are provided in a single instance. In another example, the two or more test queries may be such as,
User: “Hi, I want to know what food can I feed my 3-months old baby”
Device: “Hi, you can feed any liquid food”
User: “Ok. tell me how frequently should my baby drink water”

In the above example, the two or more test queries are provided in different instances, but the two or more test queries are part of a conversation where the two or more test queries have a same context. In an embodiment, the dialogue retrieving module (211) may be configured to retrieve the one or more dialogues from the external memory in response to the one or more queries (real-time queries) provided by the user (101) based on a context of the one or more queries. In an embodiment, based on the determined context of the one or more queries by the ID assigning module (210), the dialogue retrieving module (211) may retrieve the one or more dialogues corresponding to the determined context of the one or more queries. Referring to the example in para 37, where the query is “what should my toddler eat?”, the dialogue retrieving module (211) may retrieve the one or more dialogues having the ID “Contxt2”. Further, the dialogue retrieving module (211) may retrieve the one or more dialogues such that the one or more dialogues are answers to the query. Further, the one or more dialogues selected may be modified by other modules (212). For example, the one or more dialogues to the above query may be “Best food for toddlers include fruits, bread, eggs, beans, yogurt. You can also serve sea food to toddlers”. In an embodiment, the dialogue retrieving module (211) may provide the one or more dialogues to the communication module (209) to output to the user (101).

In an embodiment, the other modules (212) may include, but not limited to, a template selection module and a response selection module.

In an embodiment, the template selection module may select a template in which the one or more dialogues are provided to the user (101). A plurality of templates may be used to store in the external memory and the template selection module may retrieve a template from the external memory based on the query. In an embodiment, the template selection module may determine the template to be used based on a training data. For example, the plurality of templates may be generated based on the plurality of conversations present in the training data. For example, for a query “how are you?”, the template may be “I am fine”. Here, the bold phrase is the template and the phrase “fine” may be based on the context of the query.

In an embodiment, the response selection module may be configured to select the best dialogue from the one or more dialogues retrieved by the dialogue retrieving module (211). For example, the consider a query “what should I feed to my toddler who is vegetarian?” and the following one or more dialogues “Best food for toddlers include fruits, bread, beans, yogurt”, and “Yes you can serve sea food to toddlers”. Here, response selection module may select the dialogue “Best food for toddlers include fruits, bread, beans, yogurt” as the appropriate answer to the query as the dialogue “Yes you can serve sea food to toddlers” is not appropriate for a vegetarian. Further, the response selection module may also modify the selected response according to the template selected by the template selection module.

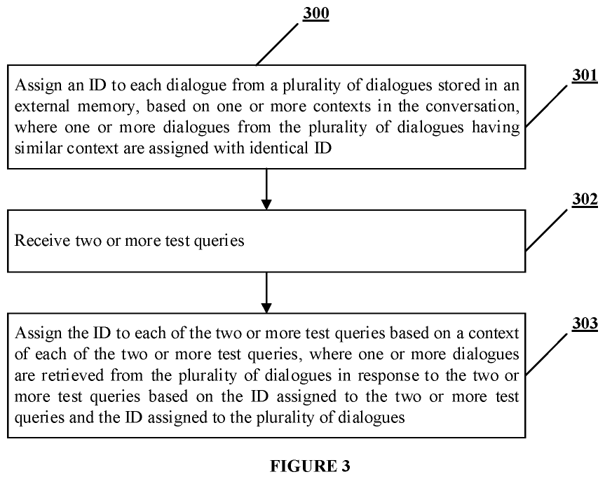

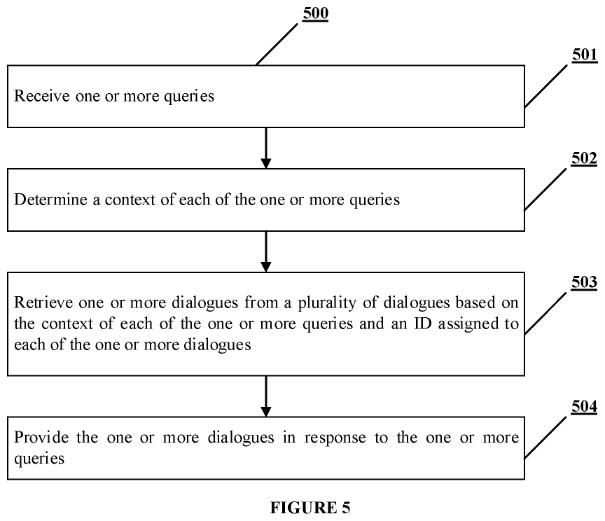

FIGS. 3 and 5 are flowcharts. FIG. 3 illustrates a flow chart for training a digital assistant device to preserve context in a conversation, in accordance with an embodiment of the present disclosure. FIG. 5 illustrates a flow chart for preserving a context in a conversation by a digital assistant device, in accordance with an embodiment of the present disclosure

As illustrated in FIGS. 3 and 5, the method (300) and (500) may comprise one or more steps. The method (300) and (500) may be described in the general context of computer executable instructions. Generally, computer executable instructions can include routines, programs, objects, components, data structures, procedures, modules, and functions, which perform particular functions or implement particular abstract data types.

The order in which the method (300) and (500) are described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step (301), an ID is assigned to each dialogue from the plurality of dialogues stored in the external memory, based on the one or more contexts in the conversations, where the one or more dialogues from the plurality of dialogues having similar contexts are assigned with identical ID. The ID assigning module (210) assigns the ID to each dialogue from the plurality of dialogues stored in the external memory. The ID is assigned based on the context of each dialogue from the plurality of dialogues in a conversation. In an embodiment, during the training phase, the communication module (209) may receive the plurality of conversations comprising the plurality of dialogues. In an embodiment, the plurality of dialogues may include one or more queries and one or more answers to the one or more queries. The plurality of dialogues may be stored in the external memory. The ID assigning module (210) may determine the context of each dialogue from the plurality of dialogues and associated a unique ID to each context. Further, after determining context of the plurality of dialogues, each dialogue is assigned a corresponding ID. Table 1 and Table 2 show the associated ID and the contexts and the dialogues under each context respectively.

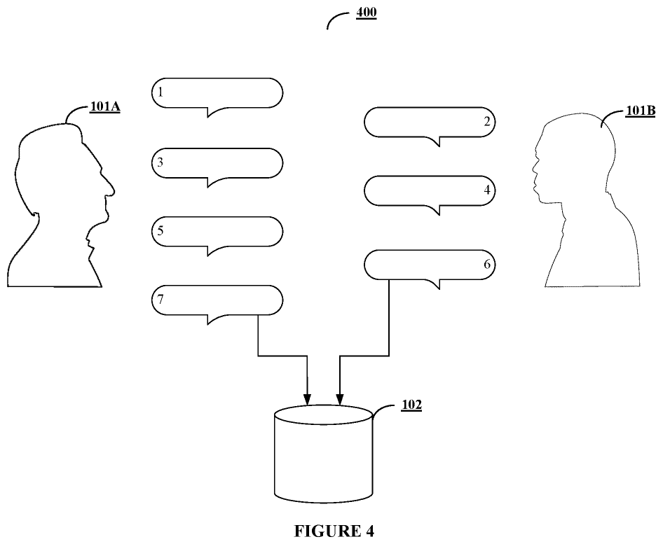

FIG. 4 shows an exemplary environment (400) of training the digital assistant device (102) with the plurality of dialogues. As shown in FIG. 4, the digital assistant device (102) may be provided with a plurality of conversations between two users (101A and 101B). In an embodiment, the two users (101A and 101B) may be a customer (e.g., 101A) and a domain expert such as a paediatrician (101B). Following is an example conversation between the customer (101A) and the paediatrician (101B):

TABLE 3

| ID | User | Dialogues |
|---|---|---|
| 1 | Customer | At what age do you give table food? |
| 2 | Paediatrician | What is the current age of your child? |
| 3 | Customer | My 8 month old tries to get her hands on everything, |
| | | but has no teeth yet, what are some safe table foods/ |
| | | drinks to give? |
| 4 | Paediatrician | Please be careful how much to give, and how big the |
| | | pieces were, also make sure it isn't too salty, sugar- |
| | | filled or containing a lot of milk. |
| 5 | Customer | Okay what kind of foods would be good? |
| 6 | Paediatrician | You can let the baby try things like bananas, bread |
| | | products, tater tots, etc. |
| 7 | Customer | Okay. Thank you. That was helpful. |

Table 3 shows a conventional technique of assigning ID to each dialogue, where the ID is assigned to each dialogue serially and does not consider the context of each dialogue. In a memN2N, as the dialogues are retrieved from the external memory, the dialogues are retrieved according to the ID and the retrieved dialogues in the conventional techniques may not be accurate. In the present disclosure, the context of each dialogue is determined and accordingly, the ID is assigned. Table 4 shows the assigning ID according to the present disclosure. As shown in Table 4, the ID is assigned according to the context of each dialogue. As seen, from Table 4, the first dialogue is provided with an ID “1”. Subsequent five dialogues are assigned the ID “2” as the five dialogues belong to a same context. Thereafter, the sixth dialogue is assigned the ID “3”. Assigning the ID according to the context helps to preserve context when the digital assistant device (102) answers the one or more queries of the user (101).

TABLE 4

| ID | Users | Dialogues |
|---|---|---|
| 1 | Customer | At what age do you give table food? |
| 2 | Paediatrician | What is the current age of your child? |
| 2 | Customer | My 8 month old tries to get her hands on everything, |
| | | but has no teeth yet, what are some safe table foods/ |
| | | drinks to give? |
| 2 | Paediatrician | Please be careful how much to give, and how big the |
| | | pieces were, also make sure it isn't too salty, sugar- |
| | | filled or containing a lot of milk. |
| 2 | Customer | Okay what kind of foods would be good? |
| 2 | Paediatrician | You can let the baby try things like noodles, bananas, |
| | | bread products, tater tots, etc. |
| 3 | Customer | Okay. Thank you. That was helpful. |

In an embodiment, the context of the plurality of dialogues may be categorised. For example, the categories may be question state, resolving state and closure state. In an embodiment, the question state may be the state where the user (101) asks the digital assistant device (102) one or more queries. In the Table 3, the dialogue having ID “1” in Table 4 may belong to the question state, as the conversation between the customer (101A) and the paediatrician (101B) starts with the above dialogue. Further dialogues having ID “2” in Table 4) may belong to the resolving state where the paediatrician (101B) and the customer (101A) may have further queries and answers to resolve the question initially provided by the customer (101A). Thereafter, the dialogue having ID “3” in Table 4 may belong to the closure state as the dialogue indicates and end of the conversation. In an embodiment, the dialogues belonging to the closure state may also indicate the digital assistant device (102) that the context of the conversation has ended.

Referring back to FIG. 3, at step (302), two or more test queries are received. In an embodiment, after the training phase is completed, a test phase is initiated where the digital assistant device (102) is tested with two or more test queries. The test phase is initiated to test the digital assistant device (102) with different inputs and verify if the output provided by the digital assistant device (102) provides the answers to the two or more test queries according to the training provided. The communication module (209) receives the two or more test queries. In an embodiment, the two or more test queries may have a same context or may have different context. Further, the ID assigning module (210) may determine the context of each of the two or more test queries.

At step (303), the ID to each of the two or more test queries is assigned based on the context. The ID assigning module (210) may further assign each of the two queries an ID based on the determined context. In an embodiment, the two or more test queries may be assigned with the same ID when the context of the two or more test queries are same. In an embodiment, the two or more test queries may be assigned with different ID when the context of the two or more test queries are different. Furthermore, the dialogue retrieving module (211) may retrieve the one or more dialogues from the plurality of dialogues based on the ID assigned to each of the two or more test queries and the ID associated with each of the one or more dialogues. In an embodiment, during the testing phase, the digital assistant device (102) is expected to mimic the paediatrician (101B). The paediatrician (101B) may provide feedback to the digital assistant device (102) based on the answers provided by the digital assistant device (102) in response to the two or more test queries. In an embodiment, based on the feedback, the weights data may be adjusted to improve the response. In an embodiment, the one or more dialogues retrieved and the two or more test queries may form a conversation. As the two or more queries are assigned with the same ID when the context of the two or more queries are same, the one or more dialogues retrieved in response to the two or more queries also have the same context as the context of the two or more queries. Hence, the one or more dialogues and the two or more queries form a conversation having a same context.

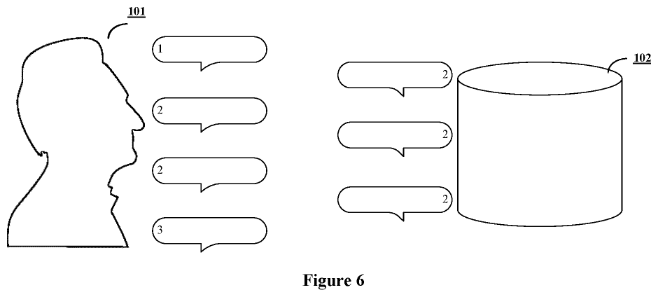

Reference is now made to FIG. 5, illustrating a flow chart for preserving a context of a conversation between the user (101) and the digital assistant device (102). The method steps of FIG. 5 are described by making reference to example illustrated in FIG. 6.

At step (501), one or more queries are received. In real-time, the communication module (209) receives one or more queries from the user (101). The communication module (209) may pre-process the one or more queries (pre-process is described in para 34).

Reference is now made to FIG. 6 where a conversation between the user (101) and the digital assistant device (102) is illustrated. The dialogues of the conversation are given in Table 5.

TABLE 5

| User/Device | Dialogues |
|---|---|
| Customer | My 2 year old daughter refuses to eat |
| Device | What kind of foods are you giving her? |
| Customer | She still takes lots of milk, but has completely refused |
| | to eat solid food. |
| Device | Stop giving her the milk, it is making her full. When |
| | she feels hungry please try introducing some solid foods |
| Customer | Sure, I'll try that |
| Device | Is there anything else I can help you with? |
| Customer | No thank you. |

Referring back to FIG. 5, at step (502), a context of each of the one or more queries is determined. The ID assigning module (210) determines a context of each of the one or more queries. For example, the dialogue “My 2 year old daughter refuses to eat” may be associated with a first context. Also, the above dialogue may be categorized under the question state. Likewise, the dialogues “She still takes lots of milk, but has completely refused to eat solid food”, “Sure, I'll try that” may be associated with a second context and the dialogues may belong to the resolving state. Further, the dialogue “No thank you” may be associated with a third context and may belong to the closure state. In an embodiment, the ID assigning module (210) may use one or more existing NLP techniques to determine the context of each of the one or more queries. The ID assigning module (210) may generate the one or more feature vectors for each of the one or more queries, and determine a relationship between the one or more feature vectors to determine the context of each of the one or more queries. In an embodiment, the determined context of each of the one or more queries may be stored in the memory (202).

At step (503), the one or more dialogues from the plurality of dialogues is retrieved based on the context of each of the one or more queries and the ID assigned to each of the one or more dialogues. The dialogue retrieving module (211) may match the context of each of the one or more queries and determines a corresponding ID associated with the context. Further, the dialogue retrieving module (211) may access the plurality of dialogues corresponding to the determined ID. Thereafter, the dialogue retrieving module (211) retrieves the one or more dialogues from the plurality of dialogues. In an embodiment, the dialogue retrieving module (211) may access the memory (202) to compare the context of each of the one or more queries with the contexts stored in the external memory. In an embodiment, the dialogue retrieving module (211) determines a relationship between the context of each of the one or more queries and the context of each of the plurality of dialogues. For example, the determined context of the one or more queries may not be exactly same as the context stored in the external memory. The dialogue retrieving module (211) may select a context from a plurality of contexts stored in the external memory, that is closest to the determined context of the one or more queries. In an embodiment, the dialogue retrieving module (211) may assign a score to each relationship between the context of each of the one or more queries and the context of the plurality of dialogues. For example, a cosine similarity may be calculated for each relationship and a score may be assigned based on the cosine similarity. In one example, a score of 9 in a scale of 1-10 may define a strong relationship and a score of 2 may define a weak relationship. In an embodiment, the dialogue retrieving module (211) may retrieve the one or more dialogues from the plurality of dialogues having a score above a threshold value. For example, a threshold of 6 may be set for retrieving the dialogues. The dialogue retrieving module (211) retrieves the one or more dialogues having the score above 6. In an embodiment, the threshold value may be dynamically set by the domain expert.

Referring to Table 5, the dialogues “What kind of foods are you giving her?”, “Stop giving her the milk, it is making her full. When she feels hungry please try introducing some solid foods”, “Is there anything else I can help you with?” may be assigned with a same ID indicating the above dialogues belong to a same context. In an embodiment, the above dialogues are retrieved as the above dialogues have a score above the threshold value. Assigning the ID is described in detail in para 45-50.

Referring back to FIG. 5, at step (504), providing the one or more dialogues in response to the one or more queries. The template selection module and the response selection module may select an appropriate template and the response to provide the one or more dialogues to the user (101). For example, the retrieved dialogues “What kind of foods are you giving her?”, “Stop giving her the milk, it is making her full. When she feels hungry please try introducing some solid foods”, “Is there anything else I can help you with?” may not be provided in one instance. The template selection module and the response selection module may select the dialogue and the template in which the dialogue should be provided to the user. The selected dialogues are provided naturally as conversing with the user (101). The response selection module may also probe the user (101) for more clarification to select the appropriate answer.

In an embodiment, in the present disclosure, the context is preserved while the user (101) converses with the digital assistant device (102). In an embodiment, an appropriate answer is provided to the user based on the context of the query by the user (101).

### Computer System

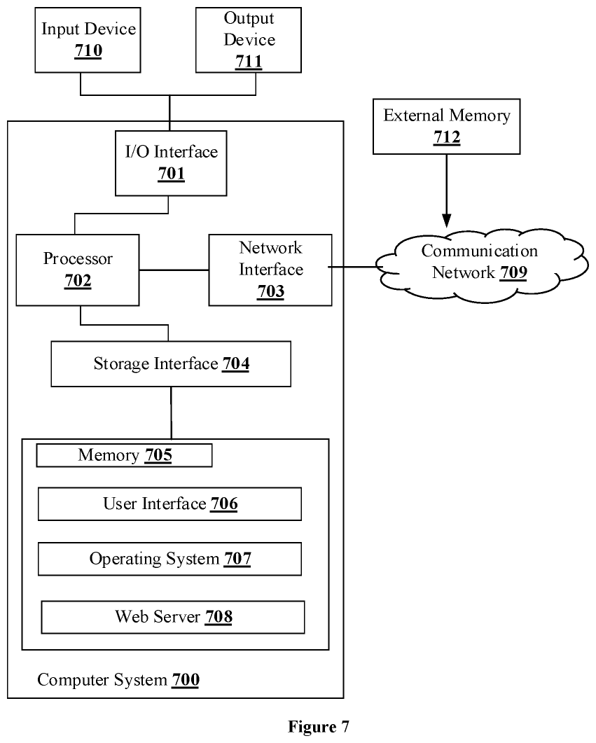

FIG. 7 illustrates a block diagram of an exemplary computer system (700) for implementing embodiments consistent with the present disclosure. The computer system (700) may comprise a central processing unit (“CPU” or “processor”) (702). The processor (702) may comprise at least one data processor for executing program components for dynamic resource allocation at run time. The processor (702) may include specialized processing units such as integrated system (bus) controllers, memory management control units, floating point units, graphics processing units, digital signal processing units, etc.

The processor (702) may be disposed in communication with one or more input/output (I/O) devices (not shown) via I/O interface (701). The I/O interface (701) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (701), the computer system (700) may communicate with one or more I/O devices. For example, the input device (710) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (711) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (700) is connected to the service operator through a communication network (709). The processor (702) may be disposed in communication with the communication network (709) via a network interface (703). The network interface (703) may communicate with the communication network (709). The network interface (703) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (709) may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface (703) and the communication network (709), the computer system (700) may communicate with the one or more service operators.

In some embodiments, the processor (702) may be disposed in communication with a memory (705) (e.g., RAM, ROM, etc. not shown in FIG. 7) via a storage interface (704). The storage interface (704) may connect to memory (705) including, without limitation, memory drives, removable disc drives, etc., employing connection protocols such as serial advanced technology attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (705) may store a collection of program or database components, including, without limitation, user interface (706), an operating system (707), web server (708) etc. In some embodiments, computer system (700) may store user/application data (706), such as the data, variables, records, etc. as described in this disclosure. Such databases may be implemented as fault-tolerant, relational, scalable, secure databases such as Oracle or Sybase.

The operating system (707) may facilitate resource management and operation of the computer system (700). Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, 10 etc.), Apple iOS, Google Android, Blackberry OS, or the like.

In some embodiments, the computer system (700) may implement a web browser (708) stored program component. The web browser (708) may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers (708) may utilize facilities such as AJAX, DHTML, Adobe Flash, JavaScript, Java, Application Programming Interfaces (APIs), etc. In some embodiments, the computer system (700) may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system (700) may implement a mail client stored program component. The mail client may be a mail viewing application, such as Apple Mail, Microsoft Entourage, Microsoft Outlook, Mozilla Thunderbird, etc.

In an embodiment, the external memory (712) may be configured to store the plurality of dialogues along with respective ID assigned during the training phase. The computer system (700) may retrieve one or more dialogues from the plurality of dialogues based on a context of one or more queries.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3, FIG. 4, and FIG. 7 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method of preserving context in a conversation, comprising:
receiving, by a digital assistant device, one or more queries;
determining, by the digital assistant device, a context of each of the one or more queries;
retrieving, by the digital assistant device, one or more dialogues from a plurality of dialogues stored in an external memory associated with the digital assistant device, based on the context of each of the one or more queries and an Identity (ID) assigned to each of the plurality of dialogues based on a context of each of the plurality of dialogues; and
providing, by the digital assistant device, the one or more dialogues in response to the one or more queries, wherein the one or more queries and the one or more dialogues form a conversation, wherein a context of the conversation is preserved when the context of the one or more queries is similar to the context of the one or more dialogues.

2. The method as claimed in claim 1 is performed by an end-to-end memory network (MEMN2N) model configured in the digital assistant device.

3. The method as claimed in claim 1, wherein determining the context of each of the one or more queries comprises:
generating one or more feature vectors for each of the one or more queries; and
applying one or more natural language processing techniques on each of the one or more feature vectors to determine the context of each of the one or more queries.

4. The method as claimed in claim 1, wherein retrieving the one or more dialogues comprises:
determining a relation between the context of each of the one or more queries and the context of each of the plurality of dialogues;
assigning a score to each relation between the context of each of the one or more queries and the context of each of the plurality of dialogues; and
retrieving the one or more dialogues from the plurality of dialogues when a score assigned to a relation between the one or more dialogues and the one or more queries is above a threshold value.

5. The method as claimed in claim 1, wherein the ID assigned to each of the one or more dialogues is identical when the context of each of the one or more dialogues are similar.

6. A digital assistant device for preserving context in a conversation, comprising:
one or more processors; and
a memory communicatively coupled to the one or more processors, storing processor executable instructions, which, on execution causes the one or more processors to:
receive one or more queries;
determine a context of each of the one or more queries;
retrieve one or more dialogues from a plurality of dialogues stored in an external memory associated with the digital assistant device, based on the context of each of the one or more queries and an Identity (ID) associated with each of the plurality of dialogues based on a context of each of the plurality of dialogues; and
provide the one or more dialogues in response to the one or more queries, wherein the one or more queries and the one or more dialogues form a conversation, wherein a context of the conversation is preserved when the context of the one or more queries is similar to the context of the one or more dialogues.

7. The digital assistant device as claimed in claim 6, implements an end-to-end memory network (MEMN2N) model.

8. The digital assistant device as claimed in claim 6, wherein the one or more processors determines the context of each of the one or more queries when the one or more processors are configured to:
generate one or more feature vectors for each of the one or more queries; and
apply one or more natural language processing techniques on each of the one or more feature vectors.

9. The digital assistant device as claimed in claim 6, wherein the one or more processors retrieves the one or more dialogues when the one or more processors are configured to:
determine a relation between the context of each of the one or more queries and the context of each of the plurality of dialogues;
assign a score to each relation between the context of each of the one or more queries and the context of each of the plurality of dialogues; and
retrieve the one or more dialogues from the plurality of dialogues when a score assigned to a relation between the one or more dialogues and the one or more queries is above a threshold value.

10. The digital assistant device as claimed in claim 6, wherein the one or more processors assign the an identical ID to each of the one or more dialogues when the context of each of the one or more dialogues are similar.

11. A method of training a digital assistant device to preserve context in a conversation, the method comprising:
assigning, by a digital assistant device (102), an Identity (ID) to each dialogue from a plurality of dialogues stored in an external memory associated with the digital assistant device, based on one or more contexts in the conversation, wherein one or more dialogues from the plurality of dialogues having similar context are assigned with identical ID;
receiving, by the digital assistant device, two or more test queries; and
assigning, by the digital assistant device, the ID to each of the two or more test queries based on a context of each of the two or more test queries, wherein the digital assistant device retrieves one or more dialogues from the plurality of dialogues in response to the two or more test queries based on the ID assigned to the two or more test queries and the ID assigned to the plurality of dialogues, wherein the two or more queries and the one or more dialogues form a conversation, wherein the context of the conversation is preserved when the context of the one or more queries is similar to the context of the one or more dialogues.
